(19) United States
(12) Patent Application Publication
(10) Pub. No.: US 2009/0135227 A1
(43) Pub. Date: May 28, 2009

(54) LIQUID JET HEAD AND LIQUID JET APPARATUS

(75) Inventor: Katsuya IDE, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/271,113

(22) Filed: Nov. 14, 2008

(30) Foreign Application Priority Data
Nov. 26, 2007 (JP) 2007-304045

(51) Int. Cl. B41J 2/145

(52) U.S. Cl. 347/40

(57) ABSTRACT

A liquid jet head includes: a plurality of nozzle blocks, each having a pressure chamber formed with a pressurizing device for pressurizing liquid and a nozzle connected to the pressure chamber for ejecting the liquid, wherein each of the nozzle blocks is equipped with (1) a supply flow path connected to the pressure chamber for supplying the liquid to the pressure chamber, and (2) a circuit substrate for applying a driving signal to the pressurizing device for pressurizing the liquid, wherein the supply flow path is positioned on the opposite side of the nozzle through the pressure chamber, and the circuit substrate is disposed to pass between adjacent ones of the supply flow paths respectively provided at the nozzle blocks.

### BACKGROUND

1. Technical Field

The present invention relates to liquid jet heads for ejecting liquid and liquid jet apparatuses equipped with the liquid jet heads.

2. Related Art

Liquid jet apparatuses that eject liquid, such as, for example, functional liquid, ink and the like onto an object, such as, a sheet of paper, a glass substrate, and the like, for forming specified patterns and images thereon have been known. In such apparatuses, pressure chambers are provided in liquid flow paths where liquid, for example, ink flows, and liquid jet heads are used wherein pressures are applied to ink in the pressure chambers by using the electrostriction of piezoelectric elements, whereby the ink is ejected as ink droplets through nozzles located at the very ends of the flow paths.

For example, the structure of a liquid jet head described in Japanese Laid-open Patent Application JP-A-63-149159 has been known. According to this structure, pressure chambers and supply flow paths (also referred to as “reservoirs”) for supplying ink in the pressure chambers are superposed in a direction orthogonal to a nozzle opening surface where nozzles are formed. This structure may be effective in reducing the plane area of the liquid jet head in a direction in parallel with the nozzle opening surface. However, the thickness of the liquid jet head which extends in a direction orthogonal to the nozzle opening surface increases. Accordingly, this structure is not suitable for reducing the thickness of the liquid jet head.

On the other hand, for example, the structure described in Japanese Laid-open Patent Application JP-A-6-234218 is often used in which pressure chambers are disposed in parallel with a nozzle opening surface where nozzles are formed. With this structure, the pressure chambers are formed such that their lengthwise direction aligns with a direction that is generally in parallel with the nozzle opening surface, whereby a vibration plate that forms a pressure application device has a large amount of deformation and displacement, and the thickness of the liquid jet head is reduced in a direction orthogonal to the nozzle opening surface where the nozzles are formed. In such a liquid jet head, the reservoirs are formed in a plane generally in parallel with the nozzle opening surface in a state in which the reservoirs do not superpose or only a portion thereof superposes with the pressure chambers.

In recent years, images photographed by digital cameras are often printed at home. For this reason, demands for smaller and lighter printers are particularly growing. In order to meet such demands, size reduction of each of the components forming a printer is necessary, and size reduction of the liquid jet heads is also demanded.

It is noted that the lengthwise direction of pressure chambers can be made shorter than before, due to the improved performance of piezoelectric elements. For this reason, the structure described in JP-A-63-149159 may be used for reducing the size of a liquid jet head. More specifically, as the pressure chambers and the reservoirs are disposed in a direction orthogonal to the nozzle opening surface, the plane size becomes smaller, compared to the structure described in JP-A-6-234218. In addition, the thickness of the liquid jet head can be made thinner than before as the lengthwise direction of the pressure chambers becomes shorter. As a result, the liquid jet head that can be sufficiently durable in practical use can be formed.

However, as well known, the liquid jet head needs to be provided with wiring members for the application of driving signals to the piezoelectric elements for driving the piezoelectric elements in order to apply pressure required for ejecting ink through the nozzles. In this case, there is a difficulty in preventing the plane size of the liquid jet head that has been reduced in size from becoming larger due to the wiring members.

### SUMMARY

In accordance with an advantage of some aspects of the invention, it is possible to solve at least a part of the problem by the following embodiments or application examples.

In accordance with an embodiment of the invention, a liquid jet head has a plurality of nozzle blocks, each having a pressure chamber formed with a pressurizing device for pressurizing liquid and a nozzle connected to the pressure chamber for ejecting the liquid, wherein each of the nozzle blocks is equipped with (1) a supply flow path connected with the pressure chamber for supplying the liquid to the pressure chamber, and (2) a circuit substrate for applying a driving signal to the pressurizing device for pressurizing the liquid, wherein the supply flow path is positioned on the opposite side of the nozzle through the pressure chamber, and the circuit substrate is disposed to pass between adjacent ones of the supply flow paths respectively provided at the nozzle blocks.

According to the structure described above, the circuit substrate that is a wiring member is disposed between adjacent ones of the supply flow paths, such that the circuit substrate does not need to be drawn around on the outer circumference of the member that forms the supply flow path. Accordingly, an increase in the plane size of the liquid jet head can be prevented. Also, the length in which the circuit substrate is to be drawn around can be shortened.

In the liquid jet head in accordance with an aspect of the embodiment of the invention, the circuit substrate may be disposed to pass through a through hole provided in the member that forms the supply flow path.

With this structure, driving signals can be applied to the piezoelectric elements that form pressurizing devices by the circuit substrate that is passed through the through hole that penetrates the member forming the supply flow path, such that the circuit substrate does not need to be drawn around the outer circumference of the member that forms the supply flow path. As a result, an increase in the plane size of the liquid jet head can be prevented.

In accordance with another embodiment of the invention, a liquid jet apparatus is equipped with the liquid jet head described above.

By using the liquid jet head described above, driving signals can be applied to the pressurizing devices from above the associated reservoirs even when many nozzle blocks are provided, such that the liquid jet head can be prevented from becoming larger in size. Accordingly, the liquid jet apparatus with a small plane size can be provided.

### BRIEF DESCRIPTION OF THE DRAWINGS

FIG. 1 is a schematic illustration of the structure of an ink jet printer in accordance with an embodiment of the invention.

FIGS. 2A-2C are schematic views of the structure of a liquid jet head in accordance with an embodiment of the invention, where FIG. 2A schematically shows a state of the liquid jet head viewed from above, FIG. 2B schematically shows a state thereof viewed in its right side direction, and FIG. 2C schematically shows a state thereof viewed from below.

FIG. 3 is a schematic cross-sectional view of a liquid jet head in accordance with an embodiment of the invention.

FIG. 4 is a schematic view showing a state in which four liquid jet heads in accordance with an embodiment of the invention are arranged side by side.

FIG. 5 is a schematic view showing a state in which a circuit substrate is disposed in the present embodiment.

FIG. 6 is a schematic view showing a supply flow path forming member in accordance with a modified example of the invention.

### DESCRIPTION OF EXEMPLARY EMBODIMENTS

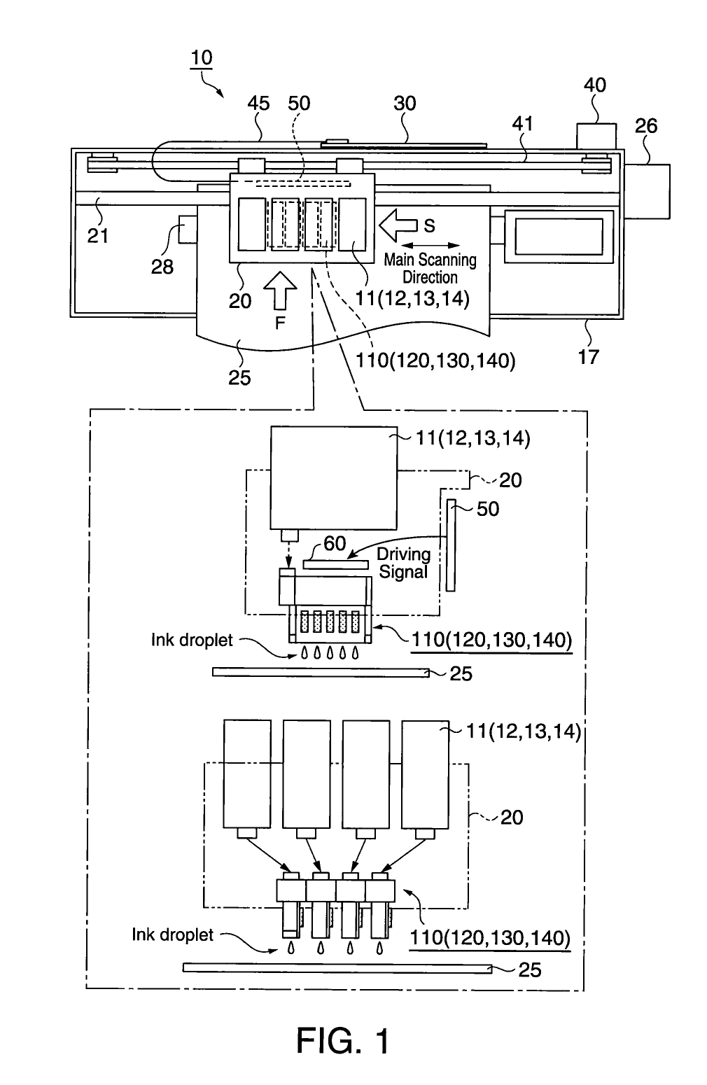

A concrete example of an embodiment of the invention is described below. FIG. 1 is a schematic view of the structure of an ink jet printer 10, which is an example of a liquid jet apparatus, equipped with liquid jet heads in accordance with an embodiment of the invention. Also, a balloon in the figure shows a schematic view (an upper side view) in which a carriage 20 to be described below is viewed in a direction of an arrow S, and a schematic view (a lower side view) in which the carriage 20 is viewed in a direction of an arrow F. It is noted that, for the convenience of description, the carriage 20 is shown in a see-through view. It is noted that, in the present embodiment, a direction viewed in the direction of the arrow F with the carriage 20 as a reference is defined as a front direction. Also, a direction viewed in the direction of the arrow S is defined as a right side direction, and its opposite side is defined as a left side direction. Also, in the following description, a direction toward printing paper 25 is defined as downside, and its opposite direction as upside.

The ink jet printer 10 includes a carriage 20 on which ink cartridges 11-14 that store liquid, such as, for example, color inks of yellow (Y), magenta (M), cyan (C) and black (K) are mounted. Four liquid jet heads 110, 120, 130 and 140 corresponding to the respective color inks are arranged side by side downside of the carriage 20, and ink droplets are ejected from the liquid jet heads 110-140 thereby printing predetermined images and the like on the printing paper 25.

The carriage 20 is affixed to a carriage belt 41, and is moved in a left-to-right direction (main scanning direction) along a guide 21 as the carriage belt 41 is driven by a carriage motor 40. Each of the liquid jet heads 110-140 is provided with a nozzle row composed of a plurality of nozzles linearly perforated in a direction orthogonal to the main scanning direction. While the carriage 20 is moving, each of the color inks is ejected from the nozzle row as ink droplets in a predetermined amount according to a printing image. The printing paper 25 is supported at its back surface by a platen 28 and moved in a predetermined amount in an up-and-down direction in the figure by paper feeding rollers (not shown) driven by a driving motor 26 affixed to a frame 17. A series of the aforementioned movements is mainly controlled by a main circuit substrate 30 mounted on the frame 17 and a sub circuit substrate 50 connected through a flexible substrate 45 and mounted on the carriage 20.

Each of the plural nozzles provided in the liquid jet heads 110-140 is formed with a pressurizing device for generating pressure for ejecting ink. The pressurizing device may be formed from a piezoelectric element having electrostriction property and a vibration plate. The piezoelectric element is deformed upon application of a predetermined voltage on the piezoelectric element, whereby ink droplets are ejected from the nozzles. The voltage for deforming the piezoelectric element is outputted from a driver substrate 60 as a driving signal for the piezoelectric element, and applied to the piezoelectric element through a circuit substrate to be described below that electrically connects the driver substrate 60 and the piezoelectric element. The driver substrates 60 are provided within the carriage 20 at positions above the liquid jet heads 110-140, corresponding to the liquid jet heads 110-140, respectively. The driver substrate 60 is wired to the sub circuit substrate 50 through a wiring member not shown, and outputs driving signals upon receiving output signals from the main substrate 30.

It is noted that, within the carriage 20, flow paths (not shown) are formed for flowing ink supplied from each of the ink cartridges 11-14 to an ink inlet port provided at each of the four liquid jet heads 110-140, as shown by an arrow with broken line in the balloon section in the figure.

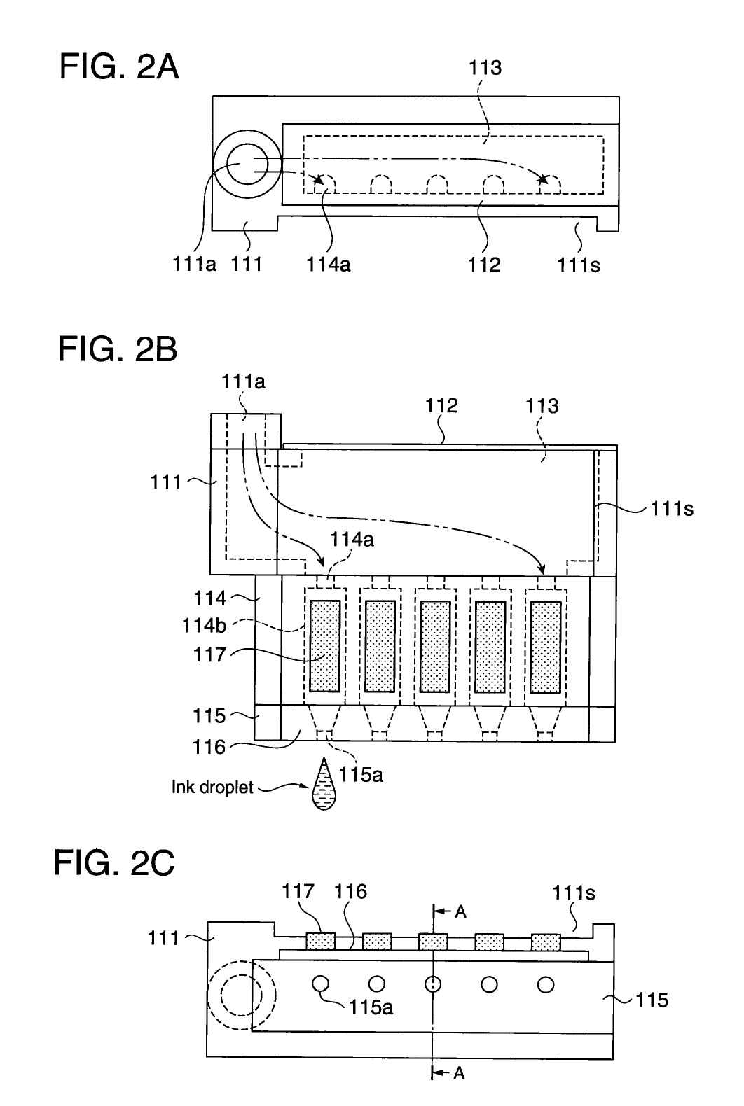

In a state in which the liquid jet heads 110-140 in accordance with the present embodiment are arranged side by side in this manner on the carriage 20, when the circuit substrates described above are disposed, the liquid jet heads would not occupy a large plane area as viewed from above. The liquid jet heads 110, 120, 130 and 140 are described with reference to FIGS. 2-4. It is noted that, in accordance with the present embodiment, the liquid jet heads 110, 120, 130 and 140 may have the same structure. Accordingly, only the liquid jet head 110 is described below.

FIGS. 2A-2C are schematic views of the structure of the liquid jet head 110. FIG. 2A schematically shows a state of the liquid jet head 110 viewed from above, FIG. 2B schematically shows a state thereof viewed in the right side direction, and FIG. 2C schematically shows a state thereof viewed from below. The structure of the liquid jet head 110 in accordance with the present embodiment is described along the ink flow path.

First, as shown in FIG. 2A, ink supplied from the ink cartridge (11) flows in a supply flow path forming member 111 having an ink inlet port 111a that is an opening section. The ink flowed in the supply flow path forming member 111 is reserved in a supply flow path 113 formed therein (hereafter referred to as a “reservoir”). The reservoir 113 is formed from the supply flow path forming member 111, a thin film member 112 and a pressure chamber forming member 114, which surround the reservoir 113, as shown in FIG. 2B.

Then, the ink flows from the reservoir 113 to communication holes 114a provided at five locations, as shown by two-dot and dash lines in the figure. The communication holes 114a are formed from semicircular oval opening sections formed in the pressure chamber forming member 114 and a vibration plate 116.

The ink flows in the communication holes 114a then flows in pressure chambers 114b formed in the pressure chamber forming member 114, as shown in FIG. 2B. Each of the pressure chambers 114b is formed from a concave section having a predetermined cross-sectional shape (e.g., a rectangular shape in the present embodiment) formed in the pressure chamber forming member 114 and the vibration plate 116. Then, the ink flowed in the pressure chambers 114b are pressurized by the vibration plate 116 that displaces by deformation driving of the piezoelectric elements 117, and ejected as ink droplets through the nozzles 115a formed in a nozzle plate 115 and communicated with the pressure chambers 114b.

The supply flow path forming member 111, the pressure chamber forming member 114 and the nozzle plate 115 may be formed from metal material (e.g., stainless steel in the present embodiment), respectively, and laminated and fixed mutually by adhesive, welding or the like. The thin film member 112 is formed from a thin plate of resin (e.g., polyphenylene sulfide resin (PPS) in the present embodiment) having flexibility for balancing vibrations of the ink generated in the reservoir 113 by ink droplet jetting operations and the like, and is affixed to an upper surface of the supply flow path forming member 111 by adhesive or welding.

Also, the vibration plate 116 may be formed from a ceramic plate (e.g., a zirconia plate in the present embodiment), and is affixed by adhesion on right side surfaces of the pressure chamber forming member 114 and the nozzle plate 115, as shown in FIG. 2B. The piezoelectric elements 117 for pressurizing the ink in the pressure chambers 114b are attached to the surface of the vibration plate 116. Each of the piezoelectric elements 117 is narrower than the width (in the right-to-left direction in the figure) of the corresponding pressure chamber 114b, is formed from a piezoelectric material having electrostriction property, such as, lead zirconate titanate (PZT) or the like in an elongated shape in a lengthwise direction (in the up-and-down direction in the figure) of the pressure chamber 114b, and is formed in a manner to curve in the width direction upon application of a voltage. An electrode (not shown) is formed at the piezoelectric element 117, and the piezoelectric element 117 is formed in a manner to warp upon application of a predetermined driving voltage to the electrode, whereby the vibration plate 116 is deformed and the ink in the pressure chamber 114b is pressurized. The vibration plate 116 and the piezoelectric element 117 function as a pressurizing device.

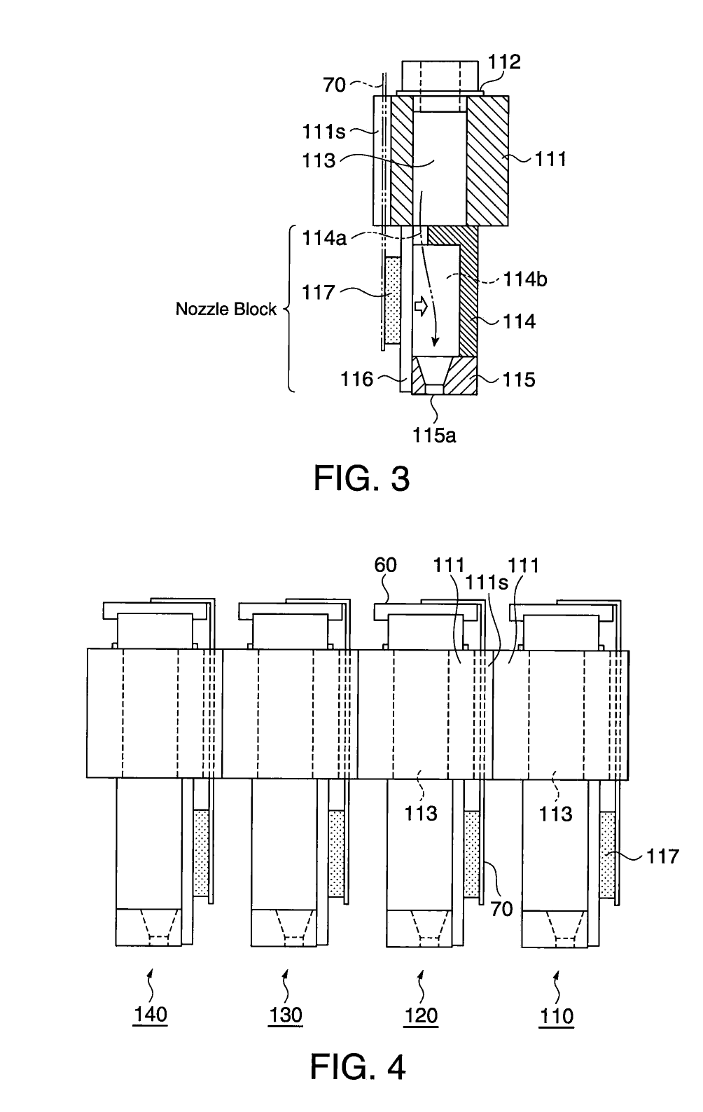

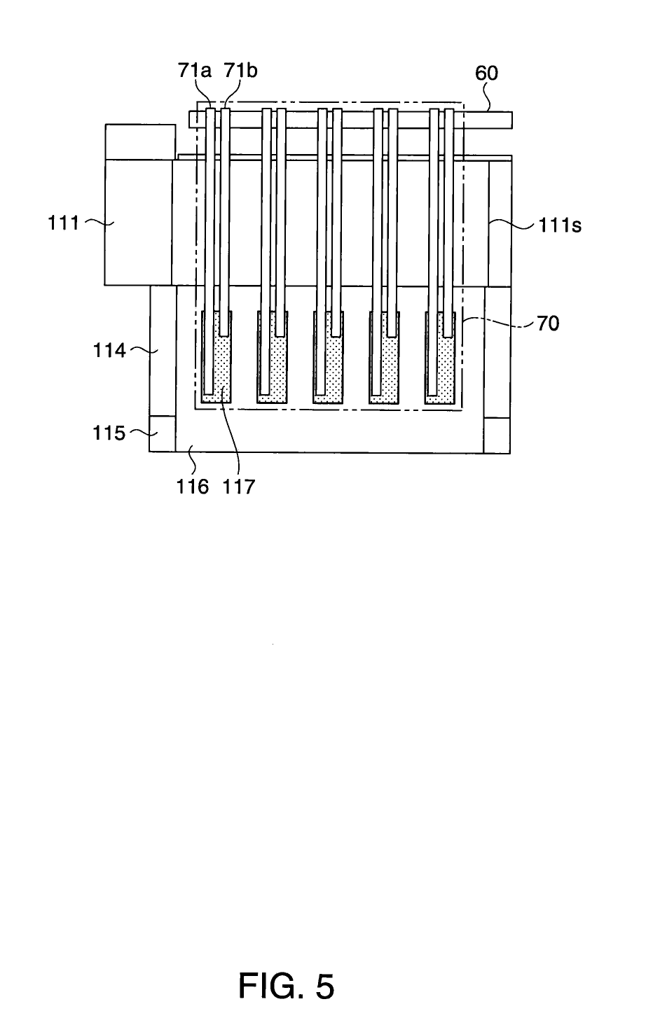

The supply flow path forming member 111 is provided with a cut section 111s having a predetermined length in the main scanning direction. The cut section 111s is used to place therein a wiring member (not shown) for applying driving signals to the piezoelectric elements 117. The placement of the wiring member is described below with reference to FIG. 3 and FIG. 4.

The liquid jet head 110 in accordance with the present embodiment has the members structured in a manner described above, and the ink flow paths formed therein as described above. As a result, as shown in FIG. 2C, the nozzle row is formed in which the nozzles 115a are arranged generally linearly at predetermined intervals at locations corresponding to the pressure chambers 114b, respectively, formed in the pressure chamber forming member 114. It is noted that the liquid jet head 110 in accordance with the present embodiment is described as having one nozzle row formed with five nozzles, for simplification of the description. However, each nozzle row is actually formed with several tens to several hundreds nozzles. It is also noted that the illustrated dimensions of the respective members are appropriately exaggerated for the convenience of description, and are therefore different from the actual dimensions.

Next, the liquid jet head 110 is described below in greater detail with reference to FIG. 3. It is noted that FIG. 3 is a schematic cross-sectional view taken along a line A-A of FIG. 2C.

As shown in FIG. 3, the pressure chamber forming member 114 and the nozzle plate 115 laminated and bonded together are laminated in a manner to form a wall surface having a single surface at least on the right side thereof. Further, as the vibration plate 116 is affixed to the wall surface, the communication holes 114a and the pressure chambers 114b extending in a direction along the wall surface in a lengthwise direction of the corresponding pressure chambers are formed in the pressure chamber forming member 114. Accordingly, the ink flow paths in the pressure chambers 114b are formed in a direction generally in parallel with the wall surface, as shown by a two-dot and dash line in the figure. As a result, when the vibration plate 116 is deformed in a direction indicated by a white arrow in the figure by deformation driving of the piezoelectric elements 117, the ink in the pressure chambers 114b is pressurized. Then, the pressurized ink in the pressure chambers 114b flows along the ink flow path, and is ejected through the nozzles 115a communicated with the pressure chambers 114b, as described above. It is noted that, in the present embodiment, the pressure chamber forming member 114, the nozzle plate 115, and the pressurizing device comprised of the vibration plate 116 and the piezoelectric elements 117 are generally referred to as a nozzle block.

A circuit substrate 70 that is a wiring member is disposed within the range of the length (and the thickness) of the cut section 111s provided in the supply flow path forming member 111, as shown by two-dot and dash lines, and is wired with the electrodes (not shown in the figure) of the piezoelectric elements 117, whereby driving signals can be applied to the electrodes.

Ink is supplied from the reservoir 113 through the communication hole 114a to refill the pressure chamber 114b with the ink for an amount ejected. Therefore, according to the liquid jet head 110, ink is supplied to all of the pressure chambers 114b (five pressure chambers in the present embodiment) from the reservoir 113 located on the opposite side of the nozzles through the pressure chambers 114b.

The communication hole 114a and the pressure chambers 114b are formed with recessed sections that may be formed in a single wall surface of a metal member in a generally cuboid shape by mechanical cutting, chemical polishing or the like. The nozzles 115a are formed in the nozzle plate 115 by mechanical works such as pressing, drilling and the like, or chemical polishing works such as etching.

With the structure described above, the liquid jet heads 110-140 in accordance with the present embodiment have a state arranged in a manner that the reservoir 113, the pressure chambers 114b and the nozzles 115a are overlapped in an up-and-down direction. As a result, the ink flow paths are formed in a direction orthogonal to the nozzle opening surface where the nozzle row is formed, such that the liquid jet heads have a smaller plane size. Further, a circuit substrate for applying driving signals to the piezoelectric elements 117 is disposed in a space contained in the thickness of the cut section 111s provided in the supply flow path forming member 111, such that the plane size of the liquid jet head would be prevented form becoming larger due to the placement of the circuit substrate. As a result, as shown in FIG. 1, even when the liquid jet heads 110-140 are arranged in the main scanning direction to form a plurality of nozzle blocks, the plane size occupied by the entire liquid jet heads can be prevented from becoming larger.

The state in which the liquid jet heads 110, 120, 130 and 140 are arranged is shown in FIG. 4. As shown in the figure, when the liquid jet heads 110-140 are arrange side by side, between adjacent ones of the liquid jet heads, for example, between the liquid jet head 110 and the liquid jet head 120, an open section extending in the up-and-down direction is formed by the cut section 111s between the supply flow path forming members 111. Accordingly, by passing the circuit substrate 70 for applying driving signals outputted from the driver substrate 60 to the piezoelectric elements 117 of the nozzle block of the liquid jet head 120 through the formed hole section, the circuit substrate 70 can be disposed between the reservoirs 113. In other words, the circuit substrate 70 does not have to be disposed being drawn around the outer circumference of the front surface side or its opposite side of the supply flow path forming member 111, and the plane size of the liquid jet head can therefore be prevented from becoming larger.

FIG. 5 is a schematic view showing the state in which the circuit substrate 70 is disposed, as viewed in the right side direction. The circuit substrate 70 is shown with its substrate indicated in a see-through view (two-dot and dash line in the figure). As shown in the figure, a pair of a wiring 71a and a wiring 71b provided on the circuit substrate 70 are electrically connected to the electrodes (not shown in the figure) formed on the respective piezoelectric elements 117, and apply driving signals outputted from the driver substrate 60 to the corresponding piezoelectric elements 117. By disposing the circuit substrate 70 in this manner, the circuit substrate 70 does not have to be drawn around the outer circumference of the front side or its opposite side of the supply flow path forming member 111, such that an increase in the plane size of the liquid jet head can be prevented. Also, the circuit substrate 70 enables the driver substrate 60 and the piezoelectric elements 117 to be wired in generally the shortest distance, such that the circuit substrate 70 does not have to be made longer, and therefore the cost of the circuit substrate 70 can be reduced.

As described above, according to the liquid jet head in accordance with the present embodiment, the circuit substrate that is a wiring member is disposed between the reservoirs without being drawn around the reservoirs that form supply flow paths, such that the circuit substrate does not need to be drawn around the outer circumference of the members that form the reservoirs, and the plane size of the liquid jet head can be prevented from becoming large. Also, the distance of drawing around the circuit substrate can be shortened, and the wiring can be simplified even with many nozzle blocks.

The invention is described above, using one embodiment. However, the invention is not limited to the embodiment, and many changes can be made within the range that does not depart from the subject matter of the invention. Some modified examples are described below.

### MODIFIED EXAMPLE

In the ink jet printer 10 in accordance with the embodiment described above, four liquid jet heads, in other words, four nozzle blocks are arranged, thereby forming a liquid jet head for ejecting inks of Y, M, C and K. Accordingly, when liquid jet heads are to be arranged side by side, steps for bonding supply flow path forming members 111 together are necessary. Therefore, in accordance with a modified example, supply flow path forming members 111 for the respective liquid jet heads may be made in one piece with a single member. In this manner, a liquid jet head having four nozzle blocks can be formed without bonding supply flow path forming members 111.

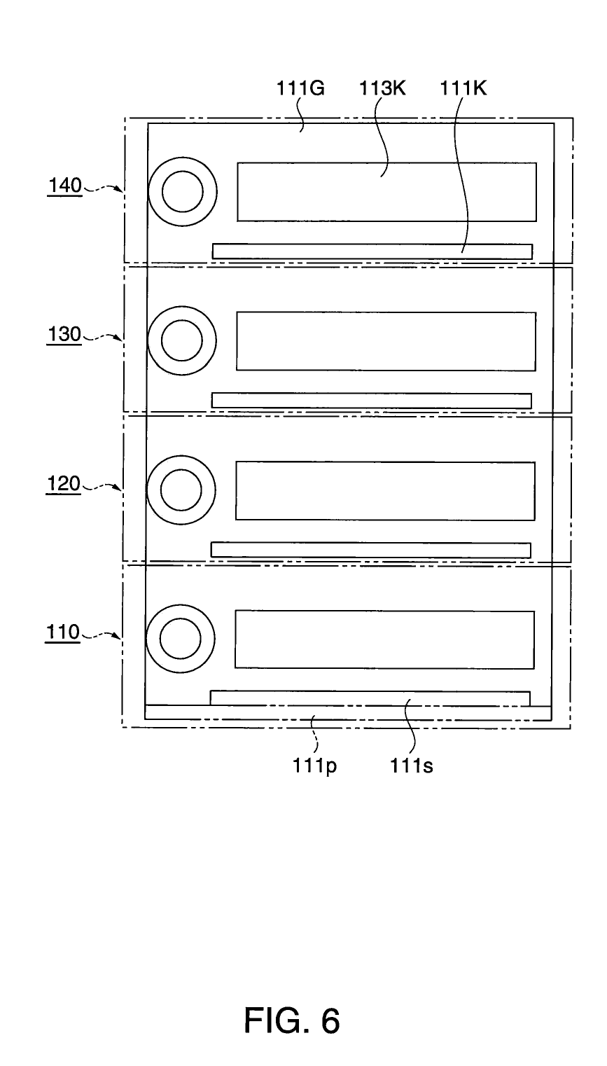

The present modified example is described with reference to FIG. 6. FIG. 6 shows a supply flow path forming member 111G that forms four nozzle blocks, which is a plan view viewed from above. As shown in the figure, four opening sections 113K that form reservoirs corresponding to respective nozzle blocks are formed in the supply flow path forming member 111G. Further, nozzle blocks (not shown) are affixed to the supply flow path forming member 111G at its lower side at predetermined positions corresponding to the respective formed opening sections 113K, whereby four liquid jet heads 110-140 are formed.

Also, three through holes 111K are formed between the opening sections 113K for passing circuit substrates 70, respectively. Furthermore, a single cut section 111s for disposing a circuit substrate 70 is formed on the right side (the lower side in the figure) of the supply flow path forming member 111G.

The circuit substrates 70 for applying driving signals to the piezoelectric elements 117 of the nozzle blocks are passed through the three through holes 111K and the single cut section 111s, respectively, whereby the circuit substrates 70 can be disposed between the reservoirs 113.

It is noted that, in accordance with the present modified example, the cut section 111s for the liquid jet head 110 can be similarly made as a through hole. In this case, a member portion 111p may be enlarged in the supply flow path forming member 111G and the cut section 111s can be made into a through hole.

### OTHER MODIFIED EXAMPLES

In the embodiments described above, the description is made as to the case where four nozzle blocks are mounted on the carriage 20. However, without any limitation to the above, the number of nozzle blocks may be increased or decreased. Without depending on the number of nozzle blocks, driving signals can be applied to pressurizing devices by the circuit substrate 70 that passes through the reservoirs 113, such that an enlargement of the size of the liquid jet head can be prevented.

Also, in the embodiments described above, the description is made as to the case of an ink jet printer for printing a predetermined image on a sheet of printing paper in which the carriage provided with the liquid jet heads for ejecting ink is reciprocated in the main scanning direction that is orthogonal to the feeding direction of the sheet of printing paper. However, the invention is not limited to the above. For example, an apparatus having an ink jet printer equipped with a line head in which nozzles are formed along the entire width of a sheet of printing paper for ejecting ink droplets on the sheet of printing paper may be used as a liquid jet apparatus in accordance with an embodiment of the invention.

Moreover, in the embodiments described above, as a liquid jet apparatus having liquid jet heads mounted thereon, an ink jet printer 10 for ejecting ink as liquid is described. However, the invention is not limited to the above. For example, the invention is also applicable to apparatuses for recording images, figures, characters and the like on an object by ejecting functional liquid by using a system for ejecting liquid, such as, for example, a manufacturing apparatus for forming wiring patterns by ejecting functional liquid on a glass substrate, a resin substrate and the like, a color filter manufacturing apparatus and the like.

Also, in the embodiments described above, as a method for ejecting ink droplets, a system that uses piezoelectric elements 117 is described. However, besides the above-described system, a so-called thermal system that ejects ink droplets by using heating devices is also applicable.

What is claimed is:

1. A liquid jet head comprising:
a plurality of nozzle blocks, each having a pressure chamber formed with a pressurizing device for pressurizing liquid and a nozzle connected to the pressure chamber for ejecting the liquid, wherein
each of the nozzle blocks is equipped with (1) a supply flow path connected to the pressure chamber for supplying the liquid to the pressure chamber, and (2) a circuit substrate for applying a driving signal to the pressurizing device for pressurizing the liquid, wherein the supply flow path is positioned on the opposite side of the nozzle through the pressure chamber, and the circuit substrate is disposed to pass between adjacent ones of the supply flow paths respectively provided at the nozzle blocks.

2. A liquid jet head according to claim 1, wherein the circuit substrate is disposed to pass through a through hole provided in a member that forms the supply flow path.

3. A liquid jet apparatus comprising the liquid jet head recited in claim 1.
